(19) United States
(12) Patent Application Publication
(10) Pub. No.: US 2008/0320266 A1
(43) Pub. Date: Dec. 25, 2008

(54) Allocating Disk Space On A Disk Drive

(76) Inventor: Frank E. Levine, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/767,150

(22) Filed: Jun. 22, 2007

(51) Int. Cl. G06F 12/00

(52) U.S. Cl. 711/170; 711/E12.001

(57) ABSTRACT

Allocating disk space on a disk drive, the disk drive controlled by a device driver and a volume manager, including receiving in the volume manager a request to allocate disk space for semi-sequential data access of structured data; retrieving, from non-volatile memory by the volume manager, information describing access times for storage locations on the disk drive; and allocating, by the volume manager in dependence upon the retrieved information, disk space for the structured data.

### BACKGROUND OF THE INVENTION

1. Field of the Invention

The field of the invention is data processing, or, more specifically, methods, apparatus, and products for allocating disk space on a disk drive.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas in which progress has been made is in allocating disk space on disk drive. The allocation of disk space for structured data, for example, is becoming more important as multidimensional datasets become more prevalent.

Multidimensional datasets include, for example, datasets for earthquake simulations and oil and gas exploration. Such data sets may be very large and require a large amount of disk space. Because the elements of such data sets are typically accessed by dimension, efficiency in multidimensional database access is dependent upon the actual physical locations on the disk drive where elements of the structured data are stored.

### SUMMARY OF THE INVENTION

Methods, apparatus, and products for allocating disk space on a disk drive, the disk drive controlled by a device driver and a volume manager, are disclosed that include receiving in the volume manager a request to allocate disk space for semi-sequential data access of structured data; retrieving, from non-volatile memory by the volume manager, information describing access times for storage locations on the disk drive; and allocating, by the volume manager in dependence upon the retrieved information, disk space for the structured data.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in allocating disk space on a disk drive according to embodiments of the present invention.

FIG. 2 sets forth a flow chart illustrating an exemplary method for allocating disk space on a disk drive according to embodiments of the present invention.

FIG. 3 sets forth a flow chart illustrating a further exemplary method for allocating disk space on a disk drive according to embodiments of the present invention.

### DETAILED DESCRIPTION OF EXEMPLARY EMBODIMENTS

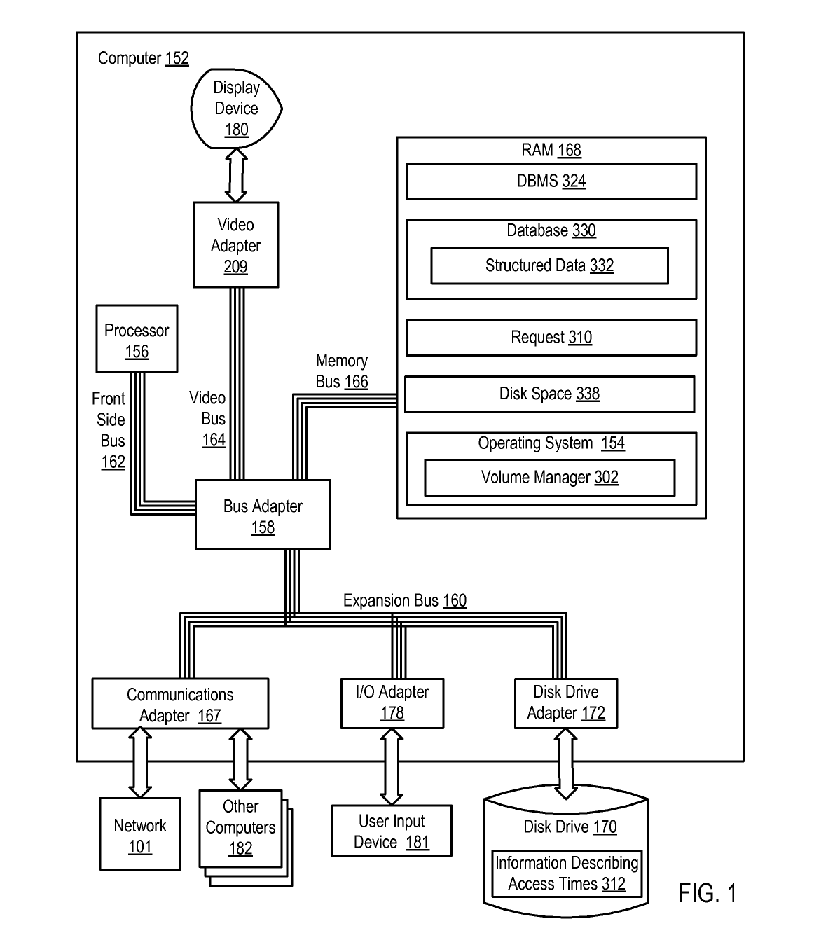

Exemplary methods, apparatus, and products for allocating disk space on a disk drive in accordance with the present invention are described with reference to the accompanying drawings, beginning with FIG. 1. Allocating disk space on a disk drive in accordance with embodiments of the present invention is generally implemented with computers, that is, with automated computing machinery. For explanation, therefore, FIG. 1 sets forth a block diagram of automated computing machinery comprising an exemplary computer (152) useful in allocating disk space on a disk drive according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) is a volume manager (320), a module of computer program instructions that allocates disk space on a disk drive (170) according to embodiments of the present invention by receiving in the volume manager (302) a request (310) to allocate disk space for semi-sequential data access of structured data (332). The volume manager may receive such a request from a database management system (‘DBMS’) (324), a module of computer program instructions that manages the organization, storage, and retrieval of data in database (330). The exemplary volume manager (302) of FIG. 1 also retrieves, from non-volatile memory, such as the disk drive (170), information (312) describing access times for storage locations on the disk drive. The volume manager (302) also allocates, in dependence upon the retrieved information, disk space (338) for the structured data (332).

Also stored in RAM (168) of the exemplary computer (152) is an operating system (154). Operating systems useful in computers according to embodiments of the present invention include UNIX™, Linux™, Microsoft Vista™, Microsoft XP™, AIX™, IBM's i5/OS™, and others as will occur to those of skill in the art. Operating system (154), volume manger (302) and the DBMS (324) in the example of FIG. 1 are shown in RAM (168), but many components of such software typically are stored in non-volatile memory also, for example, on a disk drive (170).

The computer (152) of FIG. 1 includes a bus adapter (158), a computer hardware component that contains drive electronics for the high speed buses, the front side bus (162), the video bus (164), and the memory bus (166), as well as drive electronics for the slower expansion bus (160). Examples of bus adapters useful for allocating disk space on a disk drive according to embodiments of the present invention include the Intel Northbridge, the Intel Memory Controller Hub, the Intel Southbridge, and the Intel I/O Controller Hub. Examples of expansion buses useful for allocating disk space on a disk drive according to embodiments of the present invention include Industry Standard Architecture (‘ISA’) buses and Peripheral Component Interconnect (‘PCI’) buses.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (101). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for allocating disk space on a disk drive according to embodiments of the present invention include modems for wired dial-up communications, Ethernet (IEEE 802.3) adapters for wired data communications network communications, and 802.11 adapters for wireless data communications network communications.

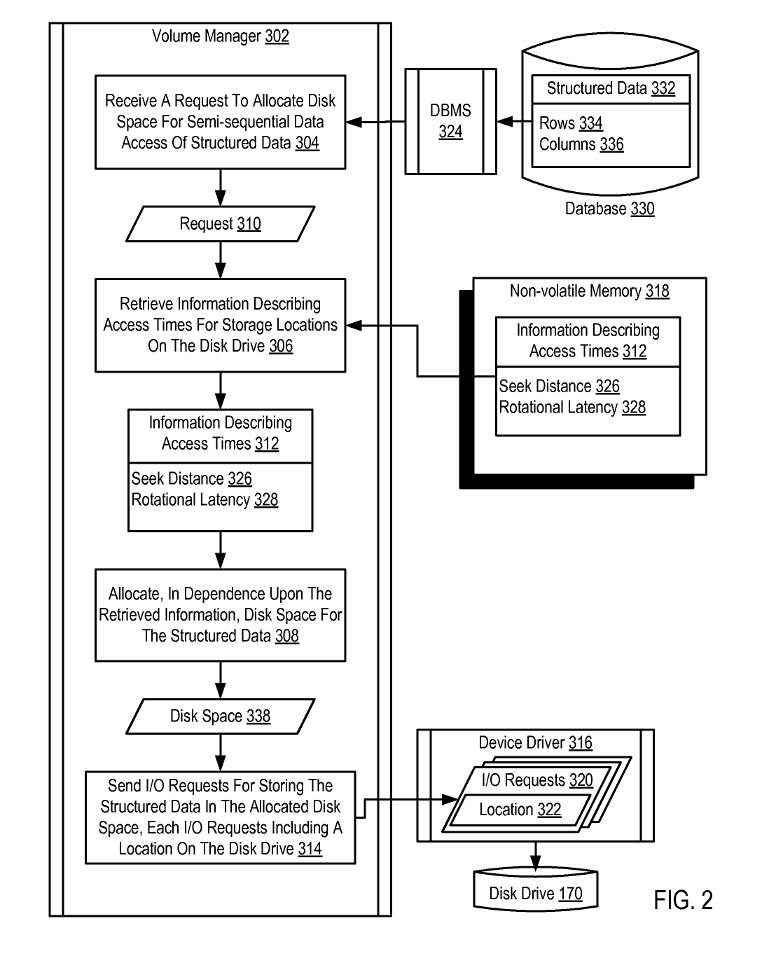

For further explanation, FIG. 2 sets forth a flow chart illustrating an exemplary method for allocating disk space on a disk drive according to embodiments of the present invention. In the method of FIG. 2 the disk drive (170) is controlled by a device driver (316) and a volume manager (302). A volume manager is a module of computer program instructions that allocates space on a disk drive and presents the disk drive as a collection of virtual partitions. Volume managers receive requests from software applications, such as DBMS (324), to read and write data from and to a disk drive. These requests typically include an identification of the virtual partition to which the data is to be read from or written to. The volume manager uses a map associating the virtual partition to actual physical locations on the disk drive to allocate disk space. That is, the volume manager uses the map to convert software applications' read and write requests, including an identification of a virtual partition, to an I/O request including an actual physical location on the hard disk drive.

The method of FIG. 2 includes receiving (304) in the volume manager (302) a request (310) to allocate disk space for semi-sequential data access of structured data (332). Structured data is data having specified relationships among elements of the data, such as, for example, records and fields or rows and columns structured according to a schema in a database. In the method of FIG. 2, for example, the structured data (322) includes data representing rows (334) and data representing columns (336) in a database (330). That is, structured data may be a table having columns and rows, the columns and rows having a structured relationship with one another. A volume manager may receive requests to allocate disk space for semi-sequential data access of structured data from many sources, such as for example, a database management system (‘DBMS’). A DMBS is a module of computer program instructions that manages the organization, storage, and retrieval of data in the database (330). In the method of FIG. 2 the volume manger receives requests to allocate disk space for semi-sequential data access of structured data from the DBMS (324).

Access to data on a disk drive may be characterized as sequential, non-sequential, or semi-sequential, depending upon the actual physical location of the data on the disk drive. A disk drive comprises a plurality of platters. Each platter is divided into concentric, circular tracks and each track is divided into sectors. A cylinder represents a collection of tracks aligned through the stack of platters on the disk drive. The number of cylinders of a disk drive, then, exactly equals the number of tracks on a single platter in the drive. Data is written to and read from the surface of a platter by a device called a disk drive head. Each platter has two sides and two heads, one for writing to and reading from each side of the platter. An actual physical location on a disk drive, therefore, may be represented as a sector, on a cylinder, on a side of a platter. For sequential access, serialized data is stored in consecutive sectors on a single track. Consider as an example of serialized data, a row containing data elements ‘X,’ ‘Y,’ and ‘Z.’For sequential access, the serialized data X, Y, and Z may be stored respectively in the consecutive sectors 1, 2, and 3 on a particular track. In contrast to sequential access, data elements for non-sequential access may be stored at any available location on the disk drive, that is, the data may be stored in no particular order. Semi-sequential access may be used to describe a type of access for data having multiple dimensions. Storing structured data for semi-sequential access retains the general structure of the data in physical locations on the disk drive. Consider the Table 1 below as an example of structured data having multiple dimensions.

TABLE 1
Structured Data Having Multiple Dimension

| | Column 1 | Column 2 |
|---|---|---|
| Row 1 | W | X |
| Row 2 | Y | Z |

Table 1 above is an example of structured data having multiple dimensions. Table 1 has two dimensions, one dimension representing columns and one dimension representing rows. Table 1 includes two columns, Column 1 and Column 2, and two rows, Row 1 and Row 2. For semi-sequential access, the elements of Row 1, W and X, may be stored in consecutive sectors on a track. The elements of Row 2, Y and Z, may be stored in consecutive sectors on an adjacent track. That is, for semi-sequential access, elements of one dimension are stored in consecutive sectors on a single track and elements of another dimension are stored in corresponding neighboring sectors on adjacent tracks. The first such dimension therefore obtains the performance of streaming bandwidth, and such data storage is ‘semi-sequential’ in the sense that there is little or no penalty for stepping from track to track to access data in the second dimension because each data element in the second dimension is in a neighboring sector, a next available sector after track-to-track seek and settle. Although structured data is described here having only two dimensions, readers of skill in the art will immediately recognize that structured data useful in allocating disk space on a disk drive according to embodiments of the present invention may include any number of dimensions.

Requests (310) to allocate disk space for semi-sequential data access of structured data (322) may include an identification of a structure of the data. That is, the request (310) to allocate disk space for semi-sequential data access of structured data identifies whether particular elements of the structured data are to be in consecutive sectors of a track or stored on adjacent tracks. A request to allocate disk space for semi-sequential data access of the structure data represented in Table 1, for example, may identify that elements W and X are to be stored in consecutive sectors of a track, elements W and Y are to be stored on adjacent tracks, and elements Y and Z are to be stored in consecutive sectors on a track.

The method of FIG. 2 also includes retrieving (306), from non-volatile memory (318) by the volume manager (302), information (312) describing access times for storage locations on the disk drive (170). ‘Access time,’ as the term is used in this specification refers to the time required to move a read/write head (or heads in the case of a stack of disk platters) from its current location, upon beginning execution of an I/O request, to the disk cylinder and sector where data is to be accessed for a next I/O request (‘the target sector’). Access time typically include seek time from a head's initial location to a target cylinder, settle time on the target cylinder, and rotational latency to the target sector. Seek time is the time necessary for the head to move from its initial cylinder location, upon beginning execution of an I/O request, to the cylinder where data is to be accessed for a new I/O request (‘target cylinder’). Settle time is the time required, after a seek to a target cylinder, for a head to stabilize on the target cylinder so that the head is capable of reading or writing data on the target cylinder. Rotational latency is the time required for a target sector to rotate into a position where the sector is accessible by the head. Information describing access times for storage locations on a disk drive may be unique to a particular disk drive, or a particular type of disk drive, due to physical variations between one disk drive and another.

Although access times may be expressed in terms of nano, micro, and milliseconds, access times may also be expressed in other terms. Because the disk spins during the head's movement, a number of sectors may pass under the head while the head moves from one cylinder to another cylinder. In typical disk drives useful for allocating disk space on the disk drive according to embodiments of the present invention the disk is rotating at an angular velocity such that each sector requires some characteristic amount of time to move past the head(s) which are fixed with respect to the rotation of the disk. Access time therefore may be expressed in terms of a number of sectors that will rotate past the head during the time required for the head to move to a target cylinder, settle on the target cylinder, and wait for the target sector to arrive at the head. In the method of FIG. 2, for example, the information (312) describing access times for storage locations on the disk drive (170) is a table associating seek distances (326) and rotational latencies (328) for next available sectors on the disk drive. Seek distances may be expressed as a number of cylinders traversed during a seek and rotational latencies may be expressed as a number of sectors that pass under a head. Table 2 below sets forth an example implementation of the information describing access times for storage locations on the disk drive.

TABLE 2
Information Describing Access Times

| Distance (in Cylinders) | Rotational Latency (in Sectors) |
|---|---|
| 1 | 1 |
| 2 | 3 |
| 3 | 5 |
| 4 | 7 |
| 5 | 9 |
| 6 | 11 |
| 7 | 13 |
| 8 | 15 |

The example of Table 2 above includes two columns, a column representing the distance of a seek, and a column representing the rotational latency experienced during such a seek. In executing a seek traversing 3 cylinders for example, 5 sectors will pass under the head. If the current head position is at cylinder A, sector 1, a seek of four cylinders, to cylinder E, results in the next available sector being sector 6. Such information describing access times may be stored in any non-volatile memory (318) including, for example, on the disk drive itself.

Information describing access times for storage locations on the disk drive may also be implemented in other ways, as will occur to those of skill in the art, in dependence upon the configuration of disk drive. One such configuration, for example, may include a disk drive configured for Zone Bit Recording (‘ZBR’). ZBR is used in disk drives to store more sectors per track on the outer tracks than on inner tracks. On a platter comprising concentric tracks, the physical track length increases with distance from the center of the platter. That is, the circumference of each track increases with distance from the center of the platter. Holding constant the storage density, the amount of data stored in a sector, the track storage capacity increases with distance from the center of the platter. That is, the outer tracks generally have more sectors then the inner tracks. Information describing access times for storage locations on the disk drive may take into account such configuration. Such information may be implemented as a table, such as a Table 3 below.

TABLE 3
Information Describing Access Times (ZBR)

| Start Cylinder | End Cylinder | Rotational Latency (in Sectors) |
|---|---|---|
| A | B | 1 |
| A | C | 3 |
| A | D | 5 |
| A | E | 7 |
| A | F | 9 |
| A | G | 11 |
| A | H | 13 |
| A | I | 15 |

Table 3 above is similar to Table 2 above, including, as it does, a column representing rotational latencies. Table 3, however, also includes a row representing a start cylinder, the cylinder at which the head is located before executing an I/O request, and a row representing an end cylinder, the cylinder at which the head will be located after executing an I/O request. Although, Table 1 sets forth only rotational latencies for executing I/O requests beginning at cylinder A for clarity, one of skill in the art will immediately recognize that such a table will typically include rotational latencies for executing I/O requests beginning at each cylinder on the disk drive. Table 3 then takes into account any rotational latency dependencies that exist when moving a head from one track to another.

The method of FIG. 2 also includes allocating (308), by the volume manager (302) in dependence upon the retrieved information (312), disk space (338) for the structured data (332). The volume manager (302) may allocate disk space (338) for the structured data (322) by mapping the data (322) to actual physical locations on the disk drive using the information (312) describing access times to storage locations on the disk drive and using a map identifying free space on the disk drive. To allocate disk space for semi-sequential access of Table 1, for example, the volume manager may map the elements W and X to consecutive sectors on a cylinder and map the elements Y and Z to consecutive sectors beginning at the next available sector on the nearest free cylinder. If the map of free space on the disk drive indicates that the locations B2, B3, B4, B5, C1, C2, C3, and C4, are free, the volume manager may map the elements W and X to locations B2 and B3. The volume manger may be configured to select the first sector in which to store the first element of the structured data in various ways. The volume manger may, for example, be configured to select the sector having the lowest access time from the current location of the disk drive head, be configured to select a sector within an area of free space having a number of free sectors greater than a predetermined amount, or be configured in many other ways as will occur to those of skill in the art.

After mapping the locations for elements W and X, the volume manager may select a location for element Y by using the information describing access times for storage locations on the disk drive to determine the next available sector on the cylinder C. For a seek from cylinder B to cylinder C, a seek distance of one cylinder, the rotational latency, identified in Table 2 above, is one sector. That is, when the disk drive head moves from cylinder B to cylinder C, one sector passes under the head. The next available sector on nearest free cylinder from B2, then, is the sector located at C3. The volume manager maps the elements Y and Z to locations C3 and C4. Although only one way of allocating disk space for structured data is described here, readers of skill in the art will immediately recognize that allocating disk space for the structured data may be carried out in many other ways and each such way is well within the scope of the present invention.

The method of FIG. 2 also includes sending (314), to the device driver (316), I/O requests (320) for storing the structured data in the allocated disk space, each I/O request (320) comprising a location (322) on the disk drive (170). An I/O request is a request to read or write from or to a disk drive. I/O requests in accordance with embodiments of the present invention may include an identification of a cylinder, a disk drive head, and a disk drive sector. That is, an I/O request may include an identification of an actual physical location on the disk drive. In another embodiment, a sector on the disk drive may be addressed using a Relative Block Address (‘RBA’) or a Logical Block Address (‘LBA’). Upon receiving the I/O request, the device driver executes the I/O requests and stores the structured data in the actual physical locations on the disk drive identified in the I/O request.

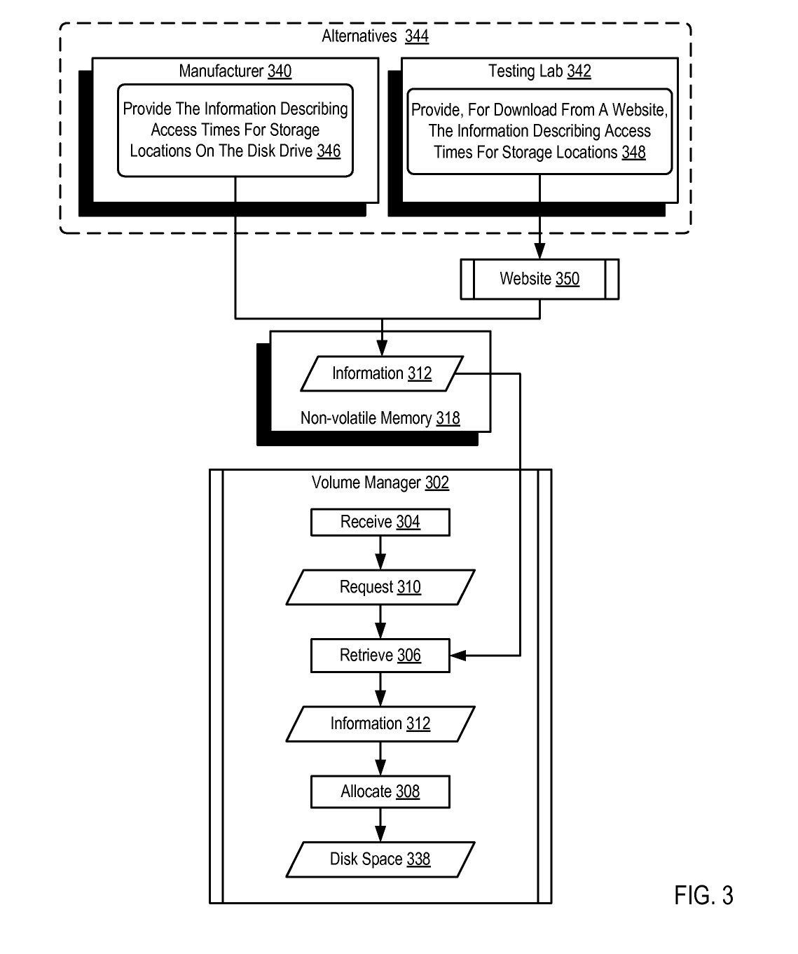

For further explanation, FIG. 3 sets forth a flow chart illustrating a further exemplary method for allocating disk space on a disk drive according to embodiments of the present invention. FIG. 3 is similar to FIG. 2 including, as it does, the volume manager's (302) receiving (304) a request (310) to allocate disk space for semi-sequential data access of structured data, retrieving (306) information (312) describing access times for storage locations on the disk drive, and allocating (308) disk space (338) for the structured data (332). The method of FIG. 3, however, also includes two alternatives (344) for providing the information describing access times for storage locations on the disk drive.

The method of FIG. 3 includes, for example, providing (346), by the manufacturer (340) of the disk drive, the information (312) describing access times for storage locations on the disk drive. The manufacturer may provide the information describing access times for storage locations on the disk drive in various ways including for example, as data stored on the disk drive itself, in an extensible markup language (‘XML’) document, in read only memory (ROM) connected to the disk drive, and so on as will occur to those of skill in the art.

The method of FIG. 3 also includes, as an alternative (344), providing (348), by a testing lab (342) for download from a website (350), the information (312) describing access times for storage locations on the disk drive. Testing labs may test a disk drive to determine the information describing access times for storage locations on the disk drive and make the results of the test available for download through a website. The download may be made freely available or to subscribers to the testing labs' results. Although only two ways of providing information describing access times for storage locations on the disk drive are described here, readers of skill in the art will immediately recognize that there may be many other ways to provide such information and each such way is well within the scope of the present invention.

Exemplary embodiments of the present invention are described largely in the context of a fully functional computer system for allocating disk space on a disk drive. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of allocating disk space on a disk drive, the disk drive controlled by a device driver and a volume manager, the method comprising:
receiving in the volume manager a request to allocate disk space for semi-sequential data access of structured data;
retrieving, from non-volatile memory by the volume manager, information describing access times for storage locations on the disk drive; and
allocating, by the volume manager in dependence upon the retrieved information, disk space for the structured data.

2. The method of claim 1 further comprising sending, to the device driver, I/O requests for storing the structured data in the allocated disk space, each I/O request comprising a location on the disk drive.

3. The method of claim 1 wherein the information describing access times for storage locations on the disk drive comprises seek distances and rotational latencies for next available sectors on the disk drive.

4. The method of claim 1 wherein the structured data comprises data representing rows and data representing columns in a database.

5. The method of claim 1 further comprising providing, by the manufacturer of the disk drive, the information describing access times for storage locations on the disk drive.

6. The method of claim 1 further comprising providing, by a testing lab for download from a website, the information describing access times for storage locations.

7. Apparatus for allocating disk space on a disk drive, the disk drive controlled by a device driver and a volume manager, the apparatus comprising a computer processor, a computer memory operatively coupled to the computer processor, the computer memory having disposed within it computer program instructions capable of:
receiving in the volume manager a request to allocate disk space for semi-sequential data access of structured data;
retrieving, from non-volatile memory by the volume manager, information describing access times for storage locations on the disk drive; and
allocating, by the volume manager in dependence upon the retrieved information, disk space for the structured data.

8. The apparatus of claim 7 further comprising computer program instructions capable of sending, to the device driver, I/O requests for storing the structured data in the allocated disk space, each I/O request comprising a location on the disk drive.

9. The apparatus of claim 7 wherein the information describing access times for storage locations on the disk drive comprises seek distances and rotational latencies for next available sectors on the disk drive.

10. The apparatus of claim 7 wherein the structured data comprises data representing rows and data representing columns in a database.

11. The apparatus of claim 7 further comprising computer program instructions capable of providing, by the manufacturer of the disk drive, the information describing access times for storage locations on the disk drive.

12. The apparatus of claim 7 further comprising computer program instructions capable of providing, by a testing lab for download from a website, the information describing access times for storage locations.

13. A computer program product for allocating disk space on a disk drive, the disk drive controlled by a device driver and a volume manager, the computer program product disposed in a computer readable, signal bearing medium, the computer program product comprising computer program instructions capable of:
receiving in the volume manager a request to allocate disk space for semi-sequential data access of structured data;
retrieving, from non-volatile memory by the volume manager, information describing access times for storage locations on the disk drive; and
allocating, by the volume manager in dependence upon the retrieved information, disk space for the structured data.

14. The computer program product of claim 13 wherein the signal bearing medium comprises a recordable medium.

15. The computer program product of claim 13 wherein the signal bearing medium comprises a transmission medium.

16. The computer program product of claim 13 further comprising computer program instructions capable of sending, to the device driver, I/O requests for storing the structured data in the allocated disk space, each I/O request comprising a location on the disk drive.

17. The computer program product of claim 13 wherein the information describing access times for storage locations on the disk drive comprises seek distances and rotational latencies for next available sectors on the disk drive.

18. The computer program product of claim 13 wherein the structured data comprises data representing rows and data representing columns in a database.

19. The computer program product of claim 13 further comprising computer program instructions capable of providing, by the manufacturer of the disk drive, the information describing access times for storage locations on the disk drive.

20. The computer program product of claim 13 further comprising computer program instructions capable of providing, by a testing lab for download from a website, the information describing access times for storage locations.
